(19) United States
(12) Patent Application Publication
(10) Pub. No.: US 2020/0201837 A1
(43) Pub. Date: Jun. 25, 2020

(54) LIVE RECORD INVALIDATION

(71) Applicant: salesforce.com, inc., San Francisco, CA (US)

(72) Inventors: Vishal Motwani, San Francisco, CA (US); Thomas Michael Jason Keeney, San Francisco, CA (US); Vivek Chauhan, San Francisco, CA (US); Kevin Venkiteswaran, Alameda, CA (US); Kamyar Seradjfar, San Francisco, CA (US); Jared Adam Pearson, Seattle, WA (US); Sheraz Khan, Bellevue, WA (US); Sahil Bhutani, San Francisco, CA (US); Mohamad Arabo, Bellevue, WA (US); Naveen Jaunk, West Sacramento, CA (US); Chandrakant Yemparala, Austin, TX (US); Alan Mathias Hoffman, San Francisco, CA (US); Badal Chhatbar, Fremont, CA (US); Ruthvik Krishna Murthy, San Francisco, CA (US); Praveen Savur, Santa Clara, CA (US); Christopher Douglas Seymour, San Francisco, CA (US); Thomas Archie Cook, Boulder, CO (US); Shikha Soni, Vancouver (CA); Kevin Schoen, Bellvue, WA (US)

(21) Appl. No.: 16/229,489

(22) Filed: Dec. 21, 2018

(51) Int. Cl. G06F 16/23; G06F 16/2455; G06F 16/84; G06F 16/38

(52) U.S. Cl. CPC G06F 16/2358; G06F 16/2365; G06F 16/381; G06F 16/24568; G06F 16/86; G06F 16/24552

(57) ABSTRACT

A database system supports live record invalidation at one or more client systems. As client system request database resources such as data objects from the database system, the database system registers entries at an object user map that indicates which objects are active and what client systems are viewing such objects. If one of the objects is changed, the database server utilizes the object user map to identify other client systems that are viewing the changed record. The database server may transmit change event indications to the client systems, and the client systems can request the updated data corresponding to the updated object.

### FIELD OF TECHNOLOGY

The present disclosure relates generally to database systems and data processing, and more specifically to live record invalidation.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, the cloud platform may provide or support one or more different client applications that allow users to view and change records stored as objects, such as customer records. If multiple users are viewing the same object, then an object update by one of the users may not be persisted to the client applications used by the other users. Thus, object inconsistencies may occur between viewed records.

### BRIEF DESCRIPTION OF THE DRAWINGS

FIG. 1 illustrates an example of a system for data processing that supports live record invalidation in accordance with aspects of the present disclosure.

FIG. 2 illustrates an example of a system that supports live record invalidation in accordance with aspects of the present disclosure.

FIG. 3 illustrates an example of a system including a server that supports live record invalidation in accordance with aspects of the present disclosure.

FIG. 4 illustrates an example of a system including a server that supports live record invalidation in accordance with aspects of the present disclosure.

FIG. 5 illustrates an example of a process flow that supports live record invalidation in accordance with aspects of the present disclosure.

FIG. 6 shows a block diagram of an apparatus that supports live record invalidation in accordance with aspects of the present disclosure.

FIG. 7 shows a block diagram of a live record tracking component that supports live record invalidation in accordance with aspects of the present disclosure.

FIG. 8 shows a diagram of a system including a device that supports live record invalidation in accordance with aspects of the present disclosure.

FIGS. 9 through 13 show flowcharts illustrating methods that support live record invalidation in accordance with aspects of the present disclosure.

### DETAILED DESCRIPTION

Users and services may access data storage of a cloud platform (e.g., via the Internet) using one or more clients, where a client may be an example of a web browser application or client specific application at a user device, such as a laptop, desktop, or mobile device, a service utilizing an application program interface (API), or other type of client. These clients may access data objects of the data storage to retrieve or edit the data objects. The data objects may correspond to various different data records such as customer records, product records, etc. Multiple different clients may access a particular object contemporaneously. For example, a user may be viewing a data object via a web browser application on a computing device, and another user may be viewing the same data object via an application on a mobile computing device. In some cases, one user may edit a contemporaneously viewed data object. The implementations described herein provide mechanisms to persist the change to the data object to other clients that are contemporaneously viewing the data object.

To persist data object changes, a database server may register user identifiers and object identifiers to an object user map on the database server. A registered user identifier corresponds to a client that views or requests the data object. Accordingly, when a client requests a particular object, a user identifier corresponding to the client and an object identifier corresponding to the requested object are registered to the object user map at the database server. If a client changes a viewed data object, the database server may detect the change and determine whether the changed data object is being “viewed” by another client system. If the object is being “viewed,” then the database server may transmit a change event indication to the viewing client system, and the client system may request the updated data object. Because the updates are notified to the client systems, the client systems are not configured to periodically update or request the data object and waste resources requesting unchanged objects. Furthermore, the indication transmitted to the “viewing” client systems may not include the updated data or data object. Rather, the client devices may determine whether to request data corresponding to the updated data object. Thus, the client systems may not receive unutilized data corresponding to the viewed data object.

In some cases, the database server monitors each change to the database and generates change event objects. Data of the change event objects may be compared to the object user map to determine whether the data objects are being viewed by client systems. In some cases, the database server may not consider changes to the database that correspond to data object creation, undeletion, gap events, or overflow events. In the cases of data object creation or undeletion, the database server may assume that an additional client is not viewing the data object (e.g., because it does not exist). In the cases of gap events or overflow events, the database server may ignore persisting updates because updating the client devices may utilize significant resources (e.g., batch events).

Because the database server monitors the database and generates the indications based on changes to the database, the data object invalidations are generated from the source of truth (e.g., the core) and transmitted out to different client systems that have registered interest in the record. The proposed system is scalable because the indications are sent to clients that may be “actively” viewing the specific changed objects.

In some cases, before transmitting the change event indication to the client systems, the database server determines whether the client systems are connected via a streaming link (e.g., a streaming API). The database server may further periodically (e.g., every five (5) minutes) update the object user map. Accordingly, if a client system does not request the data object within the five minute timeframe, the database server (or user interface (UI) component) may remove the entry corresponding to the data object from the object user map.

Aspects of the disclosure are initially described in the context of an environment supporting an on-demand database service. Aspects of the disclosure are further described in the context of specific environment supporting live record invalidation, database server diagrams, and a process flow diagram. Aspects of the disclosure are further illustrated by and described with reference to apparatus diagrams, system diagrams, and flowcharts that relate to live record invalidation.

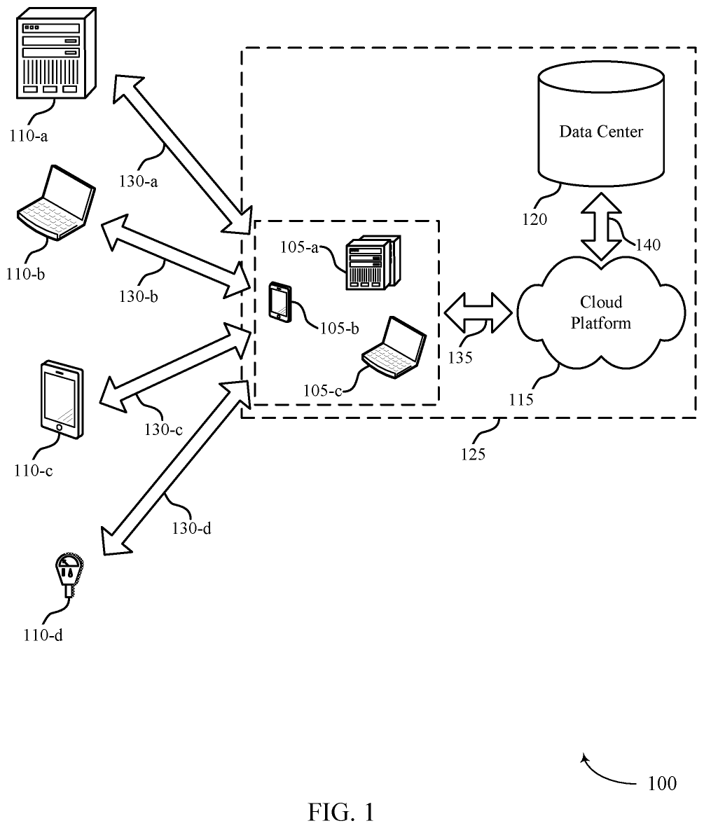

FIG. 1 illustrates an example of a system 100 for cloud computing that supports live record invalidation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

As described, the cloud platform 115 may offer an on-demand database service to the clients 105. The cloud clients 105 may access the database service using examples of web browsers, applications, APIs or other services, which may also be referred to as clients. One or more clients 105 may request, view, and edit data objects stored at the on-demand database service of the cloud platform 115. In some cases, multiple cloud clients 105 may view one or more of the same data objects contemporaneously. In certain implementations, the cloud clients utilize one or more application servers of the cloud platform 115 to access the data records. Such applications server are configured to access or utilize the implementations described herein.

In conventional systems, a client system may cache a requested and viewed data object and may refresh the record from the server after a minimum time-to-live (TTL) has expired and when a client component is requesting the same record from the cache. Thus, if there is no UI interaction triggering a UI component of the client system to fetch the record from the cache, the TTL may be expired, but an update to the data may never be requested from the server. As such, if the record is updated by another client system or another component, the update may not be persisted to the implemented UI at a client system. Furthermore, when various records have a dependent relationship, an update to a “child” record may not be revealed in the “parent” record if a triggering interaction does not cause a component to request the record. Accordingly, data corresponding to a record may be displayed in a single UI in the same client system (e.g., when the parent and child records are viewed at the same UI) or in different client systems that are viewing the same record.

In contrast, the system 100 and cloud platform 115 supports a database service that provides data updates in near real-time. If a client 105 (e.g., a device, client service, or application server of the client 105) requests a data object stored in the database system (e.g., data center 120), a live record invalidation component of the system 100 may register a user identifier corresponding to the client (e.g., the web-browser, application, API) and an object identifier of the requested data object at an object user map. The object user map serves to provide a real-time or pseudo-real-time record of active client systems. A client system may be active if it is currently or has recently requested a data object from a database system of the cloud platform 115. The database service utilizes the object user map to notify active client systems of updates to data objects. Accordingly, if multiple client systems are “viewing” a data record (e.g., the client systems have recently requested the data object) and one of the client system updates the data object, then the database system utilizes the object user map to identify the systems viewing the data object and transmits a change event indication to the identified client systems. These indications may serve to “invalidate” the data object record that may be viewed or cached at the client system. As a result, the client systems may request the updated data from the database and serve the updated data to the UI. Thus, the viewed data is updated in a near real-time manner and users of the clients 105 may not observe record inconsistencies.

Furthermore, because the client systems may not be configured to periodically update (e.g., fetch) the data records, the client systems may not waste resources by transmitting unnecessary requests (e.g., requests corresponding to data objects that have not been invalidated or updated). The indications that serve to update the client systems may not include the updated data, and the client systems may determine whether to request the updated data and which data to request. Accordingly, the database service does not waste resources transmitting data to client systems when the client systems do not “need” the updated data. This allows the message payload to remain small and minimizes pressure on the underlying streaming API transport and network infrastructure. Sending the data difference in the payload may not be practical since each user is viewing different parts of the data. For example, a client may be viewing a subset of data corresponding to a data record. Such a client system does not need to receive the entire updated data object. Rather, upon receiving the indication, the client system may request the specific data corresponding to the subset from the database server.

It should be appreciated by a person skilled in the art that one or more aspects of the disclosure may be implemented in a system 100 to additionally or alternatively solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

In one example utilization of the system 100, a user of the cloud client 105 may, using the cloud platform 115, configure a web-application. The user may be an administrative user associated with an organization (e.g., the cloud client 105), a developer writing code to support backend or frontend processes, etc. For example, an administrative user may create and customize a web-application that includes various pages and components, which access data objects stored at the data center 120. Other users associated with the organization (e.g., sales persons) may utilize the custom web application to view and edit data objects. For example, a salesperson may view and edit contact and sales information associated with a current sales client (e.g., a contact 110) using the custom web-application. Multiple salespersons of the cloud client 105 may view the information associated with the contact 110. One of the salespersons may update a data field associated with the contact 110, and the update may be persisted to the other salespersons using the implementations described herein. Thus, the salespersons may observe the updated data.

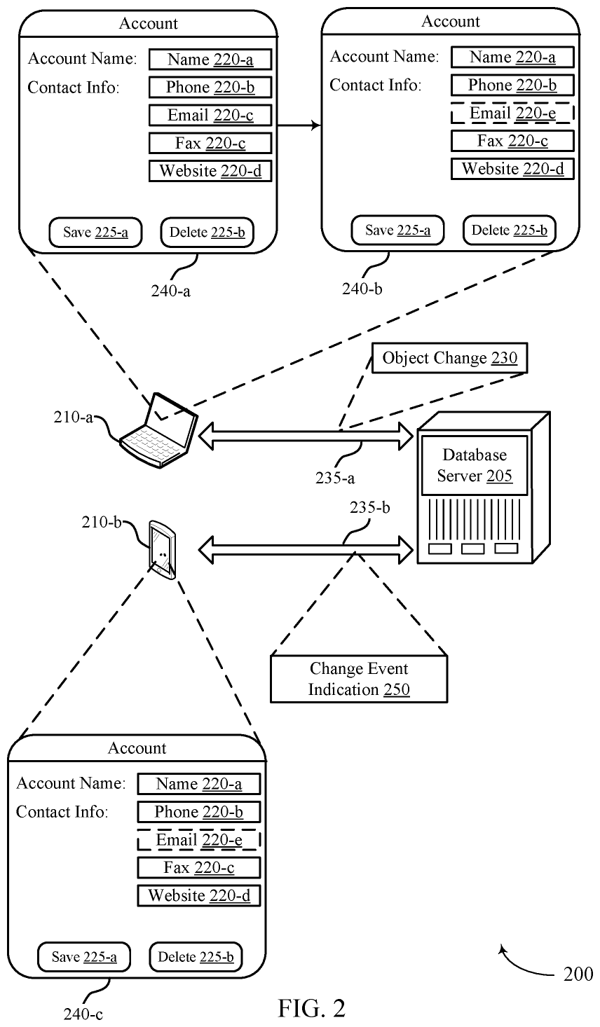

FIG. 2 illustrates an example of a system 200 that supports live record invalidation in accordance with aspects of the present disclosure. The system 200 includes devices 210 and a database server 205. The devices 210 may be examples of devices of cloud clients 105 of FIG. 1, and the database server 205 may be an example of various components of the cloud platform 115 of FIG. 1. The devices 210 execute an application configured for accessing data objects stored at the database server 205. User interfaces 240 show example displays of a data object (e.g., an account). The account may correspond to a contact 110 of FIG. 1, for example. The accounts include various data fields 220, which correspond to different information associated with the account. The user interface also include buttons 225, which may be utilized by users to save (e.g., via button 225-a) or delete (e.g., via button 225-b) data in the data fields 220.

The database server 205 communicates with the user devices 210 via communication links 235, which may be example of API links, streaming links, etc. In some cases, the devices 210 request a data object corresponding to the displayed accounts via the communication links 235. Responsive to receiving the request, the database server 205 may serve (e.g., transmit) a data object corresponding to the request to the devices 210. In some cases, the devices 210 request a subset of data corresponding to a data object. For example, depending on the components of the UI 240, a particular client may request only fields 220-a, 220-b, and 220-c of the data object. Further responsive to the request, the server 205 may register a user identifier associated with the requesting device 210 and an identifier associated with the requested data object to an object user map of the database server 205. In some cases, the object user map is hosted by an application server, which may communicatively connected to the database server 205. In some cases, the database server 205 and the application server are hosted in the same or a physically collocated computing system. The object user map serves to provide a real-time or pseudo-real-time record of active client systems and corresponding data objects. A client system may be active if it is currently or has recently requested a data object from a database system of the cloud platform 115. The database server 205 utilizes the object user map to notify active client systems of updates to data objects that are being viewed or have been recently requested by the devices 210.

In FIG. 2, the devices 210-a and 210-b are contemporaneously viewing the account via the user interfaces 240. Accordingly, the object user map of the database server 205 may include an entry including the object identifier for the account and a user identifier corresponding to the device 210-a and the device 210-b. A user of device 210-a edits the data of email field 220-c. This change is reflected in the user interface 240-a, which illustrates an email field 220-c, and the user interface 240-b, which illustrates the email field 220-e. The user may select or activate the save button 225, which may trigger an update procedure at the database server 205, which updates a data store 205, which may be. For example, the user device 210-a transmits an object change event 230 to the database server 205 via the communication link 235-a.

In response to receiving the object change event 230, the database server 205 may perform a live record invalidation process according to the implementations described herein. In some cases, the database server 205 determines whether the changed data object is listed in the object user map. If the changed data object is registered with the object user map, the database server 205 may also retrieve the user identifiers that are included in an entry with the object identifier corresponding to the changed object. The database server 205 may transmit change event indications 230 to devices have corresponding identifiers in the object user map. In FIG. 2, the database server 205 determines that an identifier associated with the device 210-b is in an entry with an object identifier associated with the changed object (e.g., indicated in the object change event 230) and transmits the change event indication 250 to the user devices 210-a. In some cases, the change event indication 250 may not include the updated data object or the updated data. Rather, the change event indication 250 may include an indication of the object identifier corresponding to the account. The device 210-a (e.g., an application on the device) may request the updated data from the database server 205 via the communication link 235-b. As illustrated, the UI 240-c displays the updated email data field 220-e.

The implementations of FIG. 2 are described with respect to database server 205, but it should be understood that an application server may implement the solutions. For example an application server may host and update the object user map, detect changes at the data store, etc. In some cases, an application server is communicatively coupled to the data store to detect the changes. In the same or alternative implementations, the database server may communicate the updates to the data store to the application server hosting the object user map.

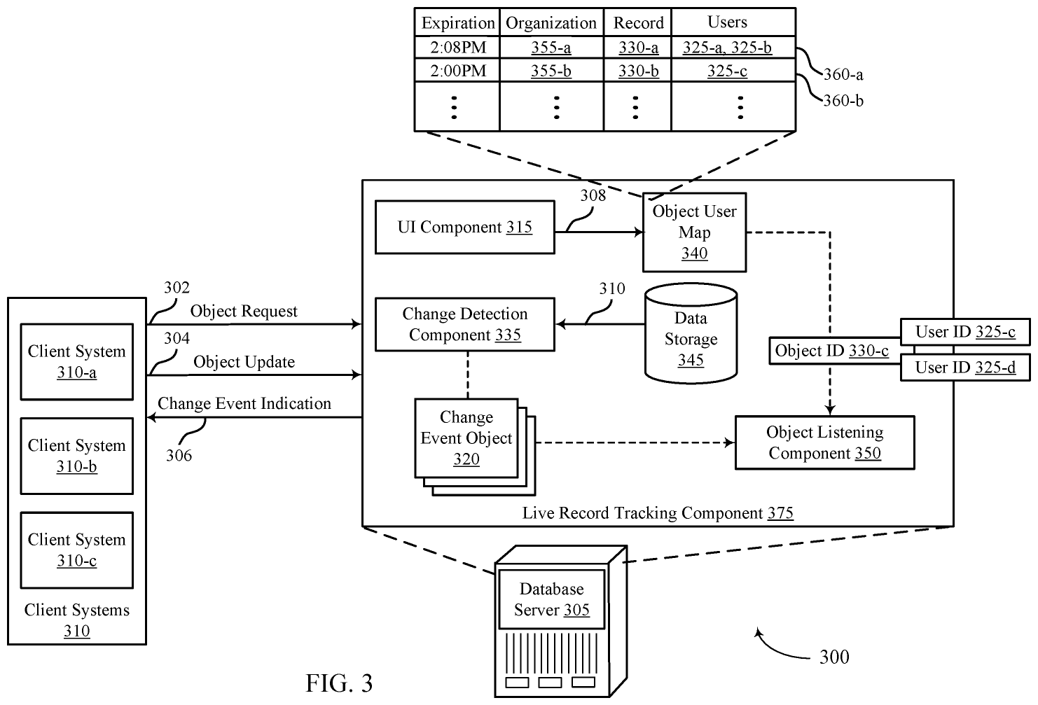

FIG. 3 illustrates an example of a system 300 including a server 305 that supports live record invalidation in accordance with aspects of the present disclosure. The system 300 further includes client systems 310, which may be examples of applications, web applications, APIs, etc. that may be executed on or utilized by a device (e.g., a client 105 or device 210 of FIGS. 1 and 2). The client systems 310 may be various different client systems utilized in different geographic locations and by different users or organizations, and the implementations described herein may function across and between various client systems. The database server 305 may be an example of a server 205 as described with respect to FIG. 2 and may include examples of components of the cloud platform 115 of FIG. 1.

The database server 305 includes a live record tracking component 375, which includes various components for supporting live record invalidation. At 302, a client system 310-a requests a data object from the database server 305. In response, the database server 305 may serve the requested object to the client system 310-a. Further in response to the request at 302, a UI component 315 of the live record tracking component 375 registers, at 308, a user identifier 325 corresponding to the device or client system 310-a and an object identifier 330 corresponding to the requested data object as a record map entry 360 at an object user map 340. The object user map 340 serves to keep a record of user devices or client systems 310 that are viewing or have recently requested data objects. Accordingly, the object user map 340 may be periodically refreshed. For example, if a data object corresponding to an entry 360 in the object user map 340 is not requested by a client system 310 within a defined time period (e.g., five minutes), then the UI component 315 may remove the entry 360 from the object user map 340. Thus, the object user map 340 is maintained to reflect a near real time record of objects that are being viewed and the devices (e.g., client systems 310) that are viewing the objects.

At 304, one of the client systems 310 updates an object via changing the data associated with the object. For example, a user of one of the client systems 310 may change data associated with the object. In some cases, a user enters new data to an existing data object, which may trigger a update procedure. In some cases, the changes are achieved using a component-based UI framework that enables the creation of dynamic, reusable interfaces (e.g., Visualforce page or Apex Trigger). The database server 305 may update the data object in data storage 345, which may an example of a data center 120 of FIG. 1. A change detection component 335 detects, at 310, the change to the data object. The change detection component 335 may leverage change data capture (CDC) techniques to detect the change to the data objects at the data storage 345. In response to detecting the changed data object, the change detection component 335 generates a change event object 320 corresponding to the changed data object. The change event object 320 may indicate the object identifier, a time associated with the change, the user identifier associated with the change, etc. In some cases, the change detection component 335 may not generate change event objects 320 corresponding to detected changes at the data storage 345. For example, if the change is a creation of a data object, then the change detection component 335 does not generate a change event object 320. As another example, if the change detection component detects a batch of changes (e.g., gap events or overflow events), then the change detection component 335 may determine to not generate corresponding change event objects 320 because persisting such changes may utilize significant resources.

An object listening component 350 of the live record tracking component 375 processes the change event objects 320 to identify client systems 310-a that may be active with respect to a changed data object. The object listening component 350 may request user identifiers 325 that are associated with object identifiers 330 in the object user map 340. For example, data object corresponding to object identifier 330-a is changed by a client system 310. The change detection component 335 detects the change at the data storage 345 and generates a change event object 320. Based on an identification of the object identifier 330 in the change event object 320, the object listening component 350 requests a listing of the user identifiers in the entry 360-a (e.g., user identifiers 325-a, 325-b) with object identifier 330-a. Thus, the object listening component 350 receives user identifiers 325-a and 325-b from the object user map 340.

The live record tracking component 375 may then transmit change event indications 306 to the client systems 310 corresponding to the user identifiers 325-c and 325-d. The indications may specify the object identifiers, time stamps, and other information. The client systems 310 may then elect to request (e.g., the object request 302) the data corresponding to the updated object. Accordingly, the client systems 310 may receive updated data in real or pseudo-real time.

In some cases, the object user map 340 is implemented as a cache system, and in some cases, a cache as a service (CaaS). In some example implementations, the object user map 340 may serialize a Java LinkedHashSet for each entry 360 in the CaaS. When the object user map 340 adds a new user to a record entry, the Java LinkedHashSet may be retrieved and deserialized from the CaaS, the user ID may be added to the set, and the previous value in the CaaS may be replaced with a new serialized version of the Java LinkedHashSet. Because these operations may utilize processing resources and take time, a compare and replace token may be utilized. When a new entry is written, if the entry fails due to invalid state (e.g., the entry was changed between read and write), the process may be started again after a random interval of time. The retry may not be immediate because it may cause an issue with connection thrashing.

In some cases, when entries are added, removed, or retrieved from the object user map 340, one or more log entries may be generated that indicate different information about the registration attempt or completion. In one scenario, the object user map 340 may generate a log that indicates the amount of time taken for registration. In another scenario, if the object user map 340 attempts to write an entry to the cache, a cache put may fail if the entry is modified by another application server or thread after the read. The object user map 340 may log the number of attempts at writing the entry and the time taken. This log entry may be useful in determining the frequency of attempts when retrying a registration entry. In another scenario, a log entry is written when there is more than one attempt to write an entry. This means a successful first attempt does not trigger a log entry. In some cases, when the object user map 340 receives a request to add or remove an entry, an asynchronous job may be enqueued. When the asynchronous job completes, a log line may be written to signify completion. Thus, the object user map 340 may generate many different logs for an entry attempt.

In some cases, the object user map 340 may implement Redis functionality to store the list of entries 360. Redis may offer built-in support for collections, and as such, registration of a new entry may involve a single operation, where the key and the new value are needed. Thus, the full version of the object user map 340 entries may not be retrieved, deserialized, and serialized. For a Redis implementation, the entries are sorted based on the score given, which may in some cases be based on a nanosecond. Multiple applications servers may have different nanotime values. However, this is not an issue because the order of the object user map 340 is not significant and may be used to remove an entry from a full set. In a Redis implementation of the object user map 340, removal of entries may be optimized by queuing removal of entries after insertions and processed with separate thread pools. This may allow the calling thread (request thread or CaaS thread) to be returned. The list may include more than a maximum amount of entries until the processing thread is selected to trigger removal.

As discussed, the UI component 315, or other system processes, may notify the object user map 340 when a user or client system 310 interacts with a data object, which may add a registration entry 360. If the data object changes, the object listening component 350 may query the object user map 340 to identify the list of user identifiers 325 for the users or client systems that have registrations entries for the changed record. After a user is registered in the object user map 340, the registration may persist for a minimum time (e.g., 5 minutes). The maximum life of a registration may be indeterminate and may be extended based on other client systems requesting information for the same record. In some cases, the object user map 340, is implemented as a first-in-first out (FIFO) queue with a maximum size and may be deduped, bunded, and ordered. Any new registrations above the maximum size may remove the oldest entries from the queue.

As an example implementation of the object user map 340, user 325-a views data object 330-a at 2:00 PM, and the database server 305 will serve the object 330-a and register the entry at the object user map 340 that will expire 5 minutes from the request (e.g., 2:05 PM). Then user 325-b views the object 330-a at 2:03 PM, and the expiration for the entry corresponding to object 330-a is updated to 2:08 PM, as illustrated in FIG. 3, and the user 325-b is added to the user list for the object 330-a and the entry 360-a. Since the entry is shared for both the user 325-a and 325-b, user 325-a is also extended to 2:08 PM. At 2:07 PM, the change detection component 335 generates a change event object 320 for the object 330-a. In this case, both the user 325-a and the user 325-b are registered and may be notified that the object 330-a has been changed.

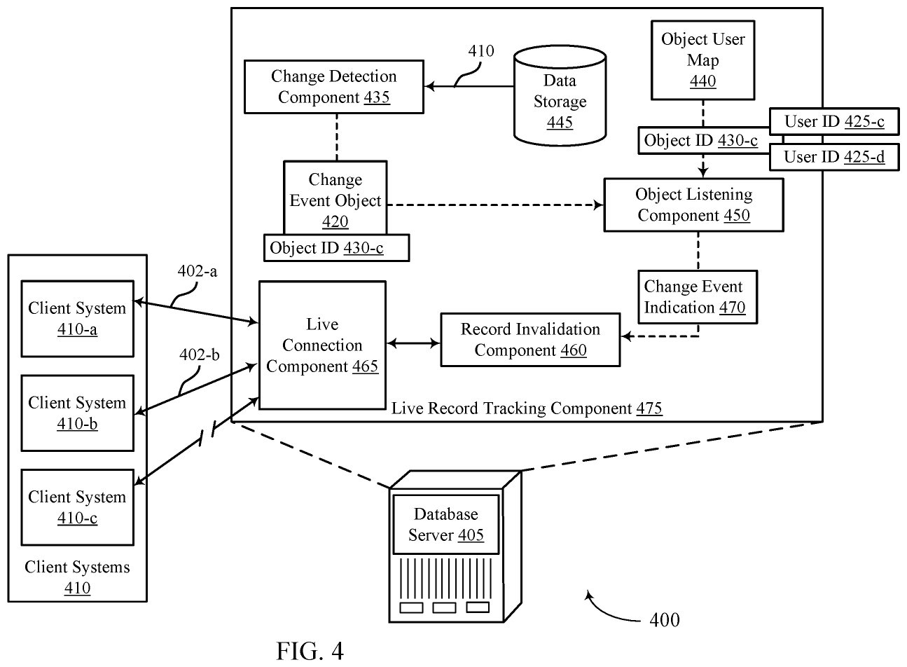

As described herein the object listening component 350 processes the change event objects 320 to identify users that may be “listening” to changed data objects. The object listening component 350 may provide an orchestration layer between data (e.g., change event objects 320) emitted by the change detection component 335 and distribution to interest users or client systems via the record invalidation component (e.g., the record invalidation component 460 of FIG. 4). The object listening component 350 may be configured to check if there are any active subscriptions on the record invalidation channel (e.g., any connected clients). If no channels are active, the processing may be aborted. The object listening component 350 may further dedupe the change event objects 320 using commit time (e.g., the timestamp). If multiple change event objects 320 include the same organization identifier 355 or object identifier 330, then the newest of such events may be processed. The object listening component 350 may also batch the change event objects 320 into chunks that optimize throughput of downstream services (e.g., the object user map 340 that is queried for user interest). The object listening component 350 may also filter the batched change event objects 320 via the object user map 340. For each batch of change event objects 320, the object listening component 350 may query the object user map 340 for the interested users set for each record in the batch. As such, the batches may include records from the same organization (e.g., based on organization identifier 355). The object listening component 350 may push the change event objects 320 with interested users to the record invalidation service (e.g., the record invalidation component 460 of FIG. 4). The object listening component 350 may run synchronously within a records update thread. In other cases, the object listening component 350 may be offloaded via asynchronous streaming or may leverage a reactive asynchronous stream processor.

The database server 305 may monitor performance statistics on how much time a thread spends on the object user map 340 and the record invalidation service. Thus, the maximum number of change event objects 320 may be optimized for a single transaction. In some cases, the change detection component 335 may leverage platform events supported by Kafka to generate the change event objects 320, and the object listening component 350 may subscribe to events generated by the change detection component 335 using the platform events system supported by Kafka. The Kafka system may provide scalability solutions to the live record tracking component 375.

The implementations of FIG. 3 are described with respect to database server 305, but it should be understood that an application server may implement the solutions described in FIG. 3. For example an application server may host and update the object user map 340, detect changes at the data store 345, etc. In some cases, an application server hosts the object user map 340 and a database server 305 hosts the data store 345. In some cases, an application server is communicatively coupled to the data store 345 to detect the changes. In the same or alternative implementations, the database server may communicate the updates to the data store to the application server hosting the object user map. Multiple application servers that serve the client systems 310 may have access to the object user map 340 and utilize the live record tracking component 375. Thus, the database server 305 comprises various components of various different applications servers and may be a multi-tenant database system and may comprise various application server and database server components.

FIG. 4 illustrates an example of a system 400 including a server 405 that supports live record invalidation in accordance with aspects of the present disclosure. The system 400 includes client systems 410, which may be examples of client systems 310 of FIG. 3. The server 405, which may be an example of the server 305 of FIG. 3, includes a live record tracking component 475, which may be an example of the live record tracking component 375 of FIG. 3. The live record tracking component 475 includes a change detection component 435, an object user map 440, and an object listening component 450, which may be examples of the corresponding components in FIG. 3.

At 410, the change detection component 435 detects a change to a data object stored at the data storage 445 and by a client system 410. The change detection component 435 determines that the detection change satisfies a change condition (e.g., the change is an “update” or a “undelete” change type). In response, the change detection component 435 generates a change event object 420 that includes an indication of an object identifier 430-c corresponding to the changed object. The object listening component 450, using the object user map 440, retrieves user identifiers that are in an entry with the object identifier 430, and thus retrieves the identifiers 425 associated with client systems 410 that are viewing or have recently requested the object corresponding to the object identifier 430-c. The object listening component 450 may generate a change event indication 470 for each client system 410 (e.g., each user identifier 425). The change event indications 470 may indicate the object identifier 430-c, user identifier 425, a time stamp associated with the change, etc.

A record invalidation component 460 leverages a live connection component 465 to determine which client systems corresponding to the user identifiers indicated by the change event indicates 470 are connected to the database server 405 and to determine how the client systems are connected. For example, the live connection component 465 may implement an HTTP based event and message routing bus (e.g., CometD web-application model), which allows the database server 405 to push notifications to client systems 410 (e.g., a browser). Thus, the client systems 410 may maintain a streaming connection 402 with the database server 405 (e.g., via subscription via an API). The record invalidation component 460, using the live connection component 465, transmits the change event indications 470 to the connected client systems 410. As illustrated, the client system 410-c is not connected to the web-browser (e.g., the streaming connection is closed), and thus may not receive change event indications 470.

After receiving the change event indications 470, the client systems may request the updated data (e.g., via streaming connection 402 or another communication link). The client systems may request a subset of the data corresponding to the updated data object, rather than receiving the updated data in the change event indication 470. This technique conserves communication resources, because a client system 410 may not be utilizing the entirety of the data corresponding to the update data object. Thus, the client system may formulate the request to receive the necessary data. The change event indications 470 are short lived, because they may be used to notify a client system's cache (e.g., in a browser) when a data object is changed.

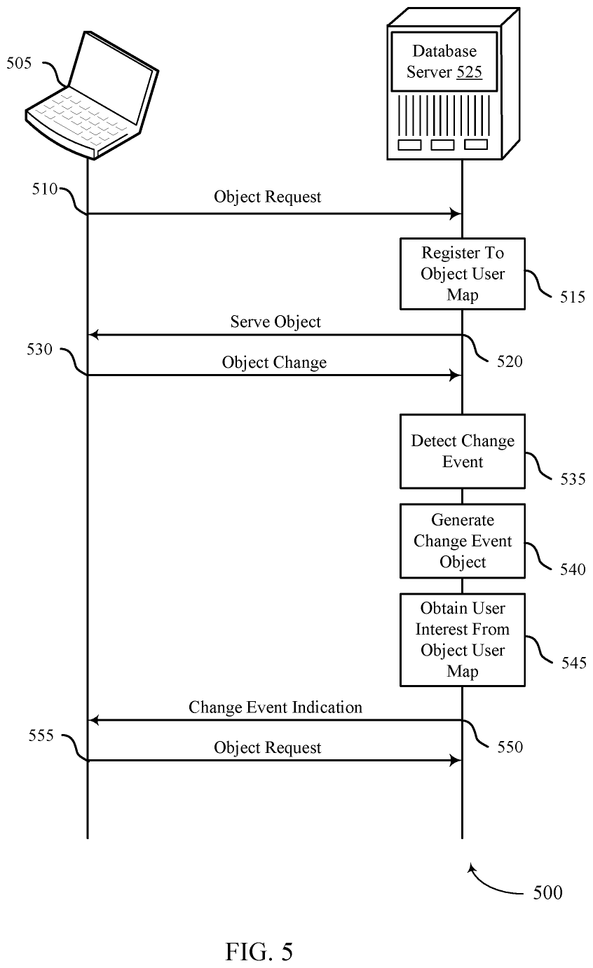

FIG. 5 illustrates an example of a process flow 500 that supports live record invalidation in accordance with aspects of the present disclosure. The process flow 500 includes a device 505 and a database server 525. The device 505 may be an example of a cloud client 105 of FIG. 1 and client systems 210, 310, and 410 of FIGS. 2-4. The database server 525 may be or include examples of components of the cloud platform 115 of FIG. 1 or may be examples of the database servers 205, 305 and 405 of FIGS. 2 through 4.

At 510, the device 505 transmits an object request to the database server 525. The object request may be transmitted responsive to a user, utilizing the device, opening or selecting a record corresponding to the data object. The object request may be transmitted via an application executing on the device, (e.g., web-application), API, or other system and may be transmitted via an application server. In some cases, the object request may be transmitted by a client system without interaction by the user. In some cases, the client system is an example of a server, database, or other computing component that is configured to interact with the database server 525 (e.g., via an API).

At 515, the database server 525 registers a user identifier corresponding to the device 505 and an object identifier corresponding to the requested object to an object user map. The object user map may include a plurality entries containing object identifiers and user identifiers that have viewed or requested the object corresponding to the object identifier of the entry. In some cases, the database server 525 may remove entries from the object user map after a predetermined period of time if a client system fails to request the object corresponding to the entry during the predetermined period of time. Thus, the entry is removed because the device may no longer be “viewing” the object or data corresponding to the object. At 520, the database server 525 serves or transmits the object, or data corresponding to the object, to the device 505.

At 530, the device 505 (or another client system) sends an object change transmission to the database server 525. The object change transmission may be transmitted responsive to the data corresponding to the data object being updated at the client system. For example, a user may update a field of data corresponding to the data object or may add additional data to the data object using a user interface of the client system.

At 535, the database server 525 detects a change event (e.g., a write process to the database) corresponding to an object of the plurality of object stored at the database server 525. Components of the database server may utilize change data capture techniques to detect the changes to the objects.

At 540, the database server 525 generates a change event object corresponding to the change event. In some cases, the database server 525 considers the change event type before generating the corresponding change event object. For example, the database server 525 may not create change event objects corresponding to an event creation or batch changes. In some cases, the change event object includes an indication of the change event type, the object identifier, a timestamp, or a combination thereof.

At 545, the database server 525 obtains user interest corresponding to the object identifier identified by the change event object to determine whether the object identifier corresponding to at least one object identifier of the object user map. For example, the database server 525 may retrieve the user identifiers that are paired with the object identifier as recorded in the object user map.

At 550, the database server 525 transmits a change event indication to at least one client system (e.g., the device 505) associated with at least one user identifier responsive to determining that the object identifier corresponds to at least one object identifier in the object user map. The change event indication indicates the change event corresponding to the object. In some cases, the change event indication indicates the object identifier, a change event type, a timestamp, or a combination thereof. In some cases, the change event indication is transmitted via a streaming API to the client systems that have subscribed to the streaming link.

At 555, the device 505 (or another client system) may request the object, or data corresponding to the object, responsive to receiving the indication from the database server 525. The request may be transmitted because the client system 505 is “viewing” or accessing the data object of the database server. In some cases, the client system may request a subset of the updated data object.

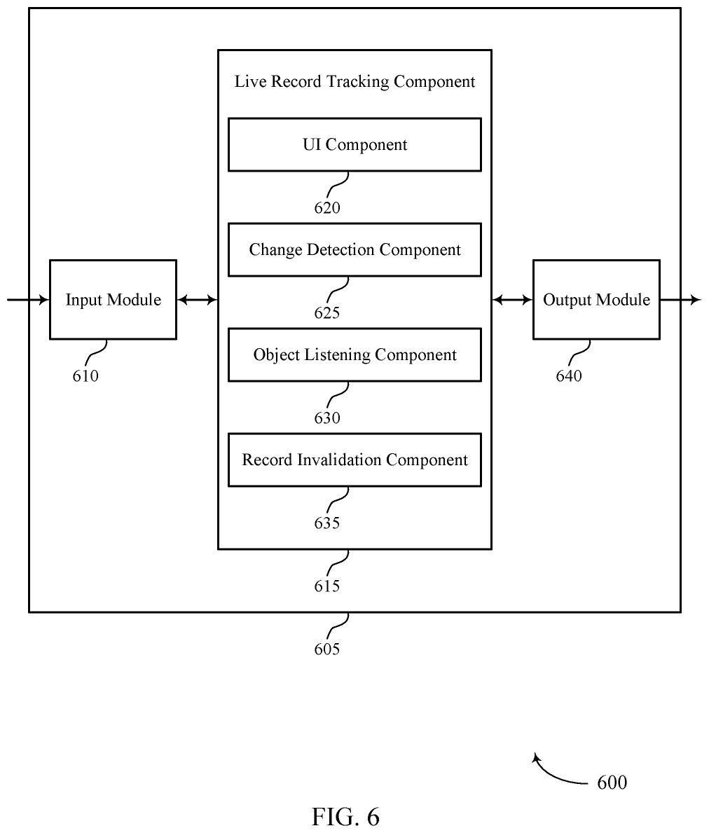

FIG. 6 shows a block diagram 600 of an apparatus 605 that supports live record invalidation in accordance with aspects of the present disclosure. The apparatus 605 may include an input module 610, a live record tracking component 615, and an output module 640. The apparatus 605 may also include a processor. Each of these components may be in communication with one another (e.g., via one or more buses). In some cases, the apparatus 605 may be an example of a user terminal, a database server, or a system containing multiple computing devices.

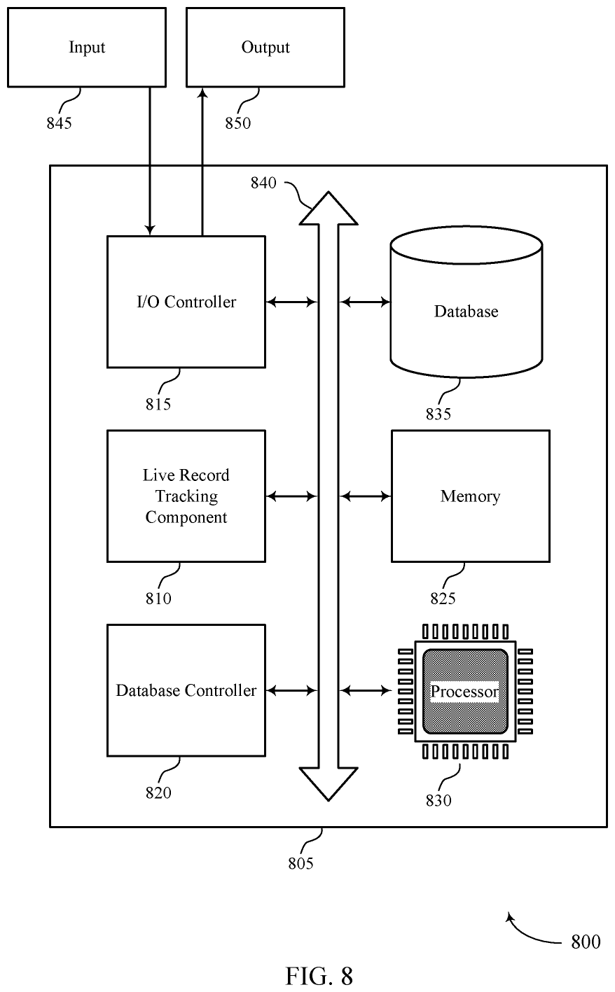

The input module 610 may manage input signals for the apparatus 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the apparatus 605 for processing. For example, the input module 610 may transmit input signals to the live record tracking component 615 to support live record invalidation. In some cases, the input module 610 may be a component of an input/output (I/O) controller 815 as described with reference to FIG. 8.

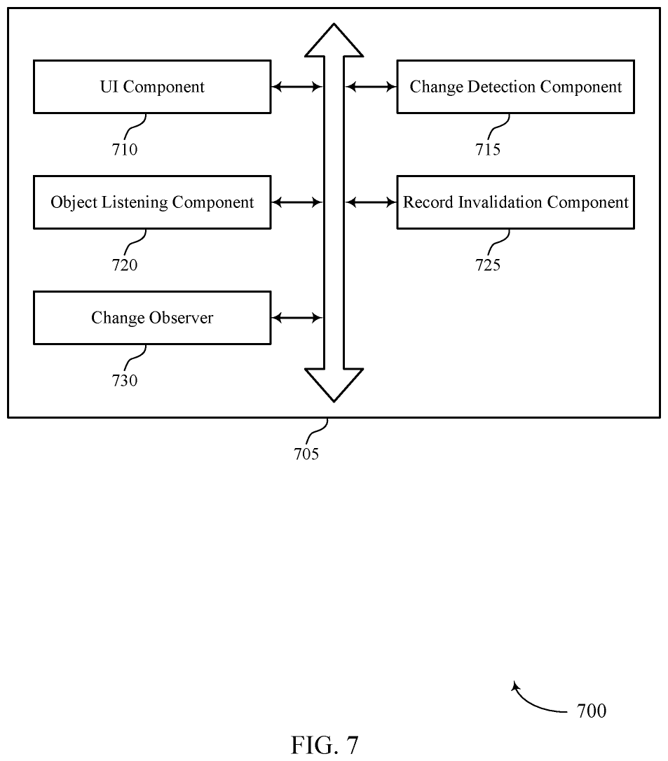

The live record tracking component 615 may include an UI component 620, a change detection component 625, an object listening component 630, and a record invalidation component 635. The live record tracking component 615 may be an example of aspects of the live record tracking component 705 or 810 described with reference to FIGS. 7 and 8.

The live record tracking component 615 and/or at least some of its various sub-components may be implemented in hardware, software executed by a processor, firmware, or any combination thereof. If implemented in software executed by a processor, the functions of the live record tracking component 615 and/or at least some of its various sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure. The live record tracking component 615 and/or at least some of its various sub-components may be physically located at various positions, including being distributed such that portions of functions are implemented at different physical locations by one or more physical devices. In some examples, the live record tracking component 615 and/or at least some of its various sub-components may be a separate and distinct component in accordance with various aspects of the present disclosure. In other examples, the live record tracking component 615 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The UI component 620 may register a first user identifier and a first object identifier as a first entry to an object user map responsive to a request for a first object associated with the first object identifier by a client system associated with the first user identifier, the object user map including a set of entries.

The change detection component 625 may detect a change event corresponding to a second object of a set of objects including the first object, the second object associated with a second object identifier.

The object listening component 630 may determine whether the second object identifier corresponds to at least one object identifier of the object user map.

The record invalidation component 635 may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

The output module 640 may manage output signals for the apparatus 605. For example, the output module 640 may receive signals from other components of the apparatus 605, such as the live record tracking component 615, and may transmit these signals to other components or devices. In some specific examples, the output module 640 may transmit output signals for display in a user interface, for storage in a database or data store, for further processing at a server or server cluster, or for any other processes at any number of devices or systems. In some cases, the output module 640 may be a component of an I/O controller 815 as described with reference to FIG. 8.

FIG. 7 shows a block diagram 700 of a live record tracking component 705 that supports live record invalidation in accordance with aspects of the present disclosure. The live record tracking component 705 may be an example of aspects of a live record tracking component 615 or a live record tracking component 810 described herein. The live record tracking component 705 may include an UI component 710, a change detection component 715, an object listening component 720, a record invalidation component 725, and a change observer 730. Each of these modules may communicate, directly or indirectly, with one another (e.g., via one or more buses).

The UI component 710 may register a first user identifier and a first object identifier as first entry to an object user map responsive to a request for a first object associated with the first object identifier by a client system associated with the first user identifier, the object user map including a set of entries.

In some examples, the UI component 710 may remove a third entry from the object user map after a predetermined period of time if a client system fails to request the object identified in the third entry during the predetermined period of time.

The change detection component 715 may detect a change event corresponding to a second object of a set of objects including the first object, the second object associated with a second object identifier.

The object listening component 720 may determine whether the second object identifier corresponds to at least one object identifier of the object user map.

In some examples, the object listening component 720 may determine that the second object identifier corresponds to the first object identifier.

In some examples, the object listening component 720 may retrieve the at least one user identifier corresponding to the second entry including the second object identifier from the object user map.

The record invalidation component 725 may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

In some examples, the record invalidation component 725 may transmit the change event indication responsive to determining the change event is one of the update event and the delete event.

In some examples, the record invalidation component 725 may determine whether the at least one client system is connected via a streaming link.

In some examples, the record invalidation component 725 may transmit the change event indication responsive to determining the at least one client system is connected via the streaming link.

In some examples, the record invalidation component 725 may transmit the change event indication to the client system associated with the first user identifier.

The change observer 730 may determine whether the change event is one of a update event and a delete event.

In some examples, the change observer 730 may generate a change event object corresponding to the detected change event, the change event object including an indication of a change event type, the second object identifier, a timestamp associated with the change event, or a combination thereof.

FIG. 8 shows a diagram of a system 800 including a device 805 that supports live record invalidation in accordance with aspects of the present disclosure. The device 805 may be an example of or include the components of a database server or an apparatus 605 as described herein. The device 805 may include components for bi-directional data communications including components for transmitting and receiving communications, including a live record tracking component 810, an I/O controller 815, a database controller 820, memory 825, a processor 830, and a database 835. These components may be in electronic communication via one or more buses (e.g., bus 840).

The live record tracking component 810 may be an example of a live record tracking component 615 or 705 as described herein. For example, the live record tracking component 810 may perform any of the methods or processes described herein with reference to FIGS. 6 and 7. In some cases, the live record tracking component 810 may be implemented in hardware, software executed by a processor, firmware, or any combination thereof.

The I/O controller 815 may manage input signals 845 and output signals 850 for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The database controller 820 may manage data storage and processing in a database 835. In some cases, a user may interact with the database controller 820. In other cases, the database controller 820 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause the processor to perform various functions described herein. In some cases, the memory 825 may contain, among other things, a basic input/output system (BIOS) which may control basic hardware or software operation such as the interaction with peripheral components or devices.

The processor 830 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in a memory 825 to perform various functions (e.g., functions or tasks supporting live record invalidation).

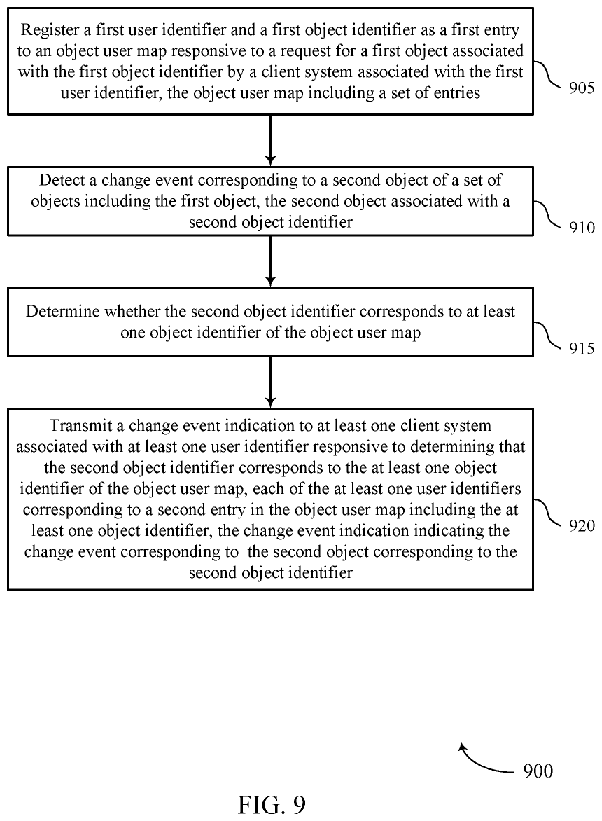

FIG. 9 shows a flowchart illustrating a method 900 that supports live record invalidation in accordance with aspects of the present disclosure. The operations of method 900 may be implemented by a database server or its components as described herein. For example, the operations of method 900 may be performed by a live record tracking component as described with reference to FIGS. 6 through 8. In some examples, a database server may execute a set of instructions to control the functional elements of the database server to perform the functions described herein. Additionally or alternatively, a database server may perform aspects of the functions described herein using special-purpose hardware.

At 905, the database server may register a first user identifier and a first object identifier as a first entry to an object user map responsive to a request for a first object associated with the first object identifier by a client system associated with the first user identifier, the object user map including a set of entries. The operations of 905 may be performed according to the methods described herein. In some examples, aspects of the operations of 905 may be performed by an UI component as described with reference to FIGS. 6 through 8.

At 910, the database server may detect a change event corresponding to a second object of a set of objects including the first object, the second object associated with a second object identifier. The operations of 910 may be performed according to the methods described herein. In some examples, aspects of the operations of 910 may be performed by a change detection component as described with reference to FIGS. 6 through 8.

At 915, the database server may determine whether the second object identifier corresponds to at least one object identifier of the object user map. The operations of 915 may be performed according to the methods described herein. In some examples, aspects of the operations of 915 may be performed by an object listening component as described with reference to FIGS. 6 through 8.

At 920, the database server may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier. The operations of 920 may be performed according to the methods described herein. In some examples, aspects of the operations of 920 may be performed by a record invalidation component as described with reference to FIGS. 6 through 8.

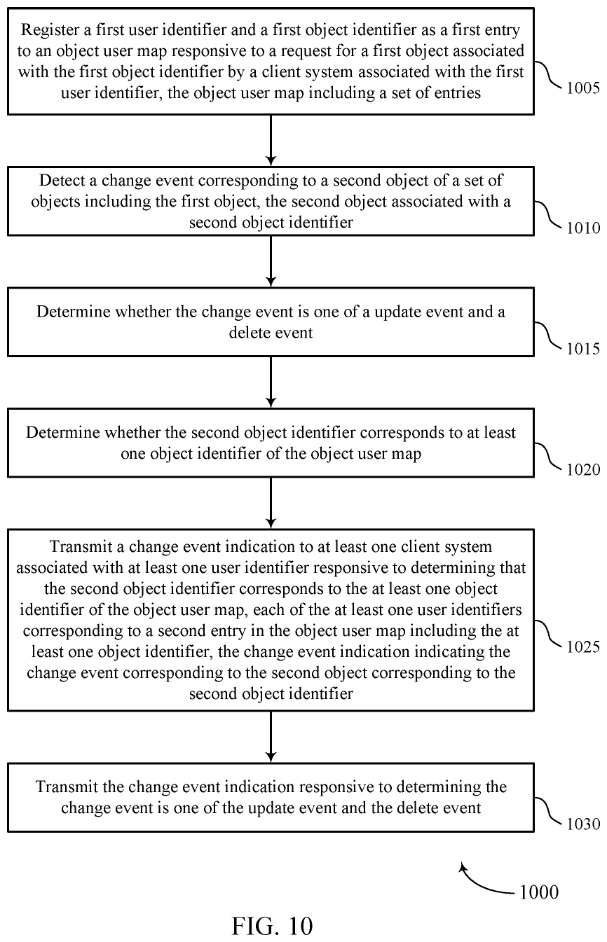

FIG. 10 shows a flowchart illustrating a method 1000 that supports live record invalidation in accordance with aspects of the present disclosure. The operations of method 1000 may be implemented by a database server or its components as described herein. For example, the operations of method 1000 may be performed by a live record tracking component as described with reference to FIGS. 6 through 8. In some examples, a database server may execute a set of instructions to control the functional elements of the database server to perform the functions described herein. Additionally or alternatively, a database server may perform aspects of the functions described herein using special-purpose hardware.

At 1005, the database server may register a first user identifier and a first object identifier as a first entry to an object user map responsive to a request for a first object associated with the first object identifier by a client system associated with the first user identifier, the object user map including a set of entries. The operations of 1005 may be performed according to the methods described herein. In some examples, aspects of the operations of 1005 may be performed by an UI component as described with reference to FIGS. 6 through 8.

At 1010, the database server may detect a change event corresponding to a second object of a set of objects including the first object, the second object associated with a second object identifier. The operations of 1010 may be performed according to the methods described herein. In some examples, aspects of the operations of 1010 may be performed by a change detection component as described with reference to FIGS. 6 through 8.

At 1015, the database server may determine whether the change event is one of a update event and a delete event. The operations of 1015 may be performed according to the methods described herein. In some examples, aspects of the operations of 1015 may be performed by a change observer as described with reference to FIGS. 6 through 8.

At 1020, the database server may determine whether the second object identifier corresponds to at least one object identifier of the object user map. The operations of 1020 may be performed according to the methods described herein. In some examples, aspects of the operations of 1020 may be performed by an object listening component as described with reference to FIGS. 6 through 8.

At 1025, the database server may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier. The operations of 1025 may be performed according to the methods described herein. In some examples, aspects of the operations of 1025 may be performed by a record invalidation component as described with reference to FIGS. 6 through 8.

At 1030, the database server may transmit the change event indication responsive to determining the change event is one of the update event and the delete event. The operations of 1030 may be performed according to the methods described herein. In some examples, aspects of the operations of 1030 may be performed by a record invalidation component as described with reference to FIGS. 6 through 8.

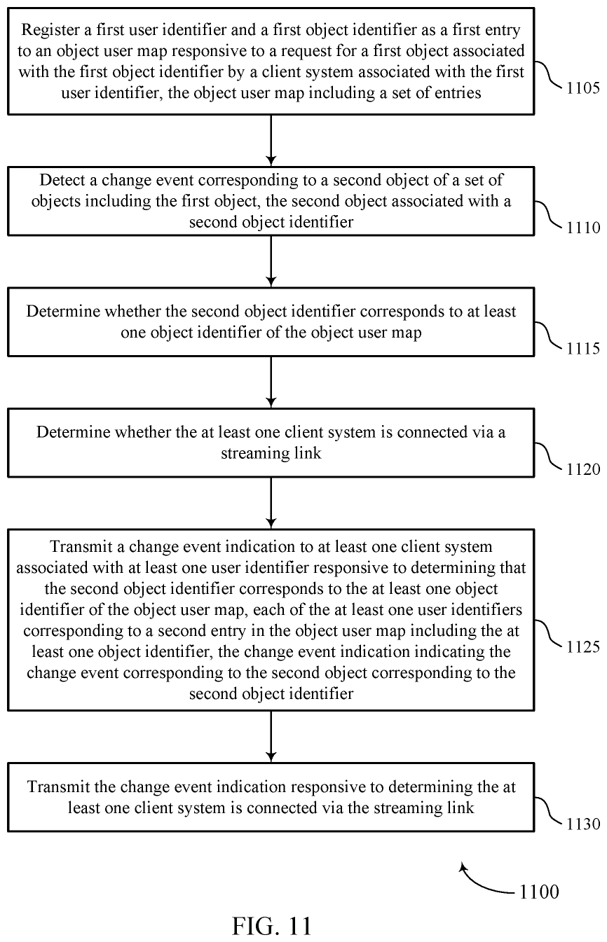

FIG. 11 shows a flowchart illustrating a method 1100 that supports live record invalidation in accordance with aspects of the present disclosure. The operations of method 1100 may be implemented by a database server or its components as described herein. For example, the operations of method 1100 may be performed by a live record tracking component as described with reference to FIGS. 6 through 8. In some examples, a database server may execute a set of instructions to control the functional elements of the database server to perform the functions described herein. Additionally or alternatively, a database server may perform aspects of the functions described herein using special-purpose hardware.

At 1105, the database server may register a first user identifier and a first object identifier as a first entry to an object user map responsive to a request for a first object associated with the first object identifier by a client system associated with the first user identifier, the object user map including a set of entries. The operations of 1105 may be performed according to the methods described herein. In some examples, aspects of the operations of 1105 may be performed by an UI component as described with reference to FIGS. 6 through 8.

At 1110, the database server may detect a change event corresponding to a second object of a set of objects including the first object, the second object associated with a second object identifier. The operations of 1110 may be performed according to the methods described herein. In some examples, aspects of the operations of 1110 may be performed by a change detection component as described with reference to FIGS. 6 through 8.

At 1115, the database server may determine whether the second object identifier corresponds to at least one object identifier of the object user map. The operations of 1115 may be performed according to the methods described herein. In some examples, aspects of the operations of 1115 may be performed by an object listening component as described with reference to FIGS. 6 through 8.

At 1120, the database server may determine whether the at least one client system is connected via a streaming link. The operations of 1120 may be performed according to the methods described herein. In some examples, aspects of the operations of 1120 may be performed by a record invalidation component as described with reference to FIGS. 6 through 8.

At 1125, the database server may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier. The operations of 1125 may be performed according to the methods described herein. In some examples, aspects of the operations of 1125 may be performed by a record invalidation component as described with reference to FIGS. 6 through 8.

At 1130, the database server may transmit the change event indication responsive to determining the at least one client system is connected via the streaming link. The operations of 1130 may be performed according to the methods described herein. In some examples, aspects of the operations of 1130 may be performed by a record invalidation component as described with reference to FIGS. 6 through 8.

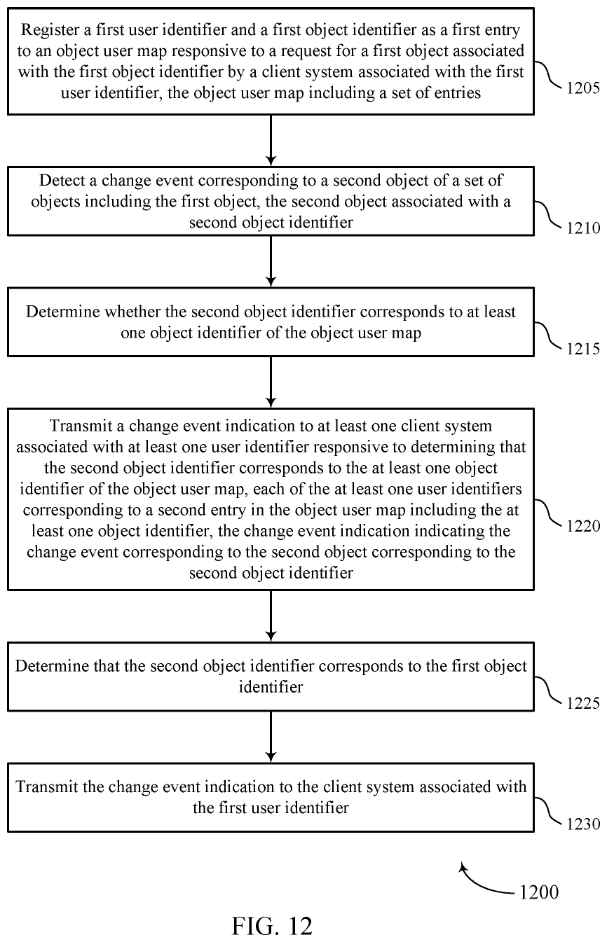

FIG. 12 shows a flowchart illustrating a method 1200 that supports live record invalidation in accordance with aspects of the present disclosure. The operations of method 1200 may be implemented by a database server or its components as described herein. For example, the operations of method 1200 may be performed by a live record tracking component as described with reference to FIGS. 6 through 8. In some examples, a database server may execute a set of instructions to control the functional elements of the database server to perform the functions described herein. Additionally or alternatively, a database server may perform aspects of the functions described herein using special-purpose hardware.

At 1205, the database server may register a first user identifier and a first object identifier as a first entry to an object user map responsive to a request for a first object associated with the first object identifier by a client system associated with the first user identifier, the object user map including a set of entries. The operations of 1205 may be performed according to the methods described herein. In some examples, aspects of the operations of 1205 may be performed by an UI component as described with reference to FIGS. 6 through 8.

At 1210, the database server may detect a change event corresponding to a second object of a set of objects including the first object, the second object associated with a second object identifier. The operations of 1210 may be performed according to the methods described herein. In some examples, aspects of the operations of 1210 may be performed by a change detection component as described with reference to FIGS. 6 through 8.

At 1215, the database server may determine whether the second object identifier corresponds to at least one object identifier of the object user map. The operations of 1215 may be performed according to the methods described herein. In some examples, aspects of the operations of 1215 may be performed by an object listening component as described with reference to FIGS. 6 through 8.

At 1220, the database server may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier. The operations of 1220 may be performed according to the methods described herein. In some examples, aspects of the operations of 1220 may be performed by a record invalidation component as described with reference to FIGS. 6 through 8.

At 1225, the database server may determine that the second object identifier corresponds to the first object identifier. The operations of 1225 may be performed according to the methods described herein. In some examples, aspects of the operations of 1225 may be performed by an object listening component as described with reference to FIGS. 6 through 8.

At 1230, the database server may transmit the change event indication to the client system associated with the first user identifier. The operations of 1230 may be performed according to the methods described herein. In some examples, aspects of the operations of 1230 may be performed by a record invalidation component as described with reference to FIGS. 6 through 8.

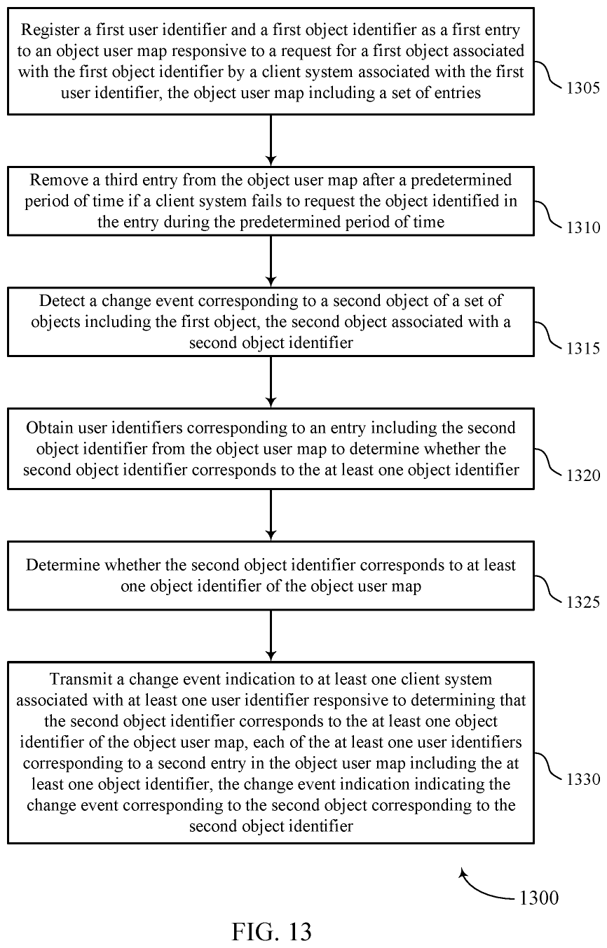

FIG. 13 shows a flowchart illustrating a method 1300 that supports live record invalidation in accordance with aspects of the present disclosure. The operations of method 1300 may be implemented by a database server or its components as described herein. For example, the operations of method 1300 may be performed by a live record tracking component as described with reference to FIGS. 6 through 8. In some examples, a database server may execute a set of instructions to control the functional elements of the database server to perform the functions described herein. Additionally or alternatively, a database server may perform aspects of the functions described herein using special-purpose hardware.

At 1305, the database server may register a first user identifier and a first object identifier as a first entry to an object user map responsive to a request for a first object associated with the first object identifier by a client system associated with the first user identifier, the object user map including a set of entries. The operations of 1305 may be performed according to the methods described herein. In some examples, aspects of the operations of 1305 may be performed by an UI component as described with reference to FIGS. 6 through 8.

At 1310, the database server may remove a third entry from the object user map after a predetermined period of time if a client system fails to request the object identified in the third entry during the predetermined period of time. The operations of 1310 may be performed according to the methods described herein. In some examples, aspects of the operations of 1310 may be performed by an UI component as described with reference to FIGS. 6 through 8.

At 1315, the database server may detect a change event corresponding to a second object of a set of objects including the first object, the second object associated with a second object identifier. The operations of 1315 may be performed according to the methods described herein. In some examples, aspects of the operations of 1315 may be performed by a change detection component as described with reference to FIGS. 6 through 8.

At 1320, the database server may retrieve the at least one user identifier corresponding to the second entry including the second object identifier from the object user map. The operations of 1320 may be performed according to the methods described herein. In some examples, aspects of the operations of 1320 may be performed by an object listening component as described with reference to FIGS. 6 through 8.

At 1325, the database server may determine whether the second object identifier corresponds to at least one object identifier of the object user map. The operations of 1325 may be performed according to the methods described herein. In some examples, aspects of the operations of 1325 may be performed by an object listening component as described with reference to FIGS. 6 through 8.

At 1330, the database server may transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier. The operations of 1330 may be performed according to the methods described herein. In some examples, aspects of the operations of 1330 may be performed by a record invalidation component as described with reference to FIGS. 6 through 8.

A method of data processing is described. The method may include registering a first user identifier and a first object identifier as a first entry to an object user map responsive to a request for a first object associated with the first object identifier by a client system associated with the first user identifier, the object user map including a set of entries, detecting a change event corresponding to a second object of a set of objects including the first object, the second object associated with a second object identifier, determining whether the second object identifier corresponds to at least one object identifier of the object user map, and transmitting a change event indication to at least one client system associated with at least one user identifier responsive to determining that the second object identifier corresponds to the at least one object identifier of the object user map, each of the at least one user identifiers corresponding to second entry in the object user map including the at least one object identifier, the change event indication indicating the change event corresponding to the second object corresponding to the second object identifier.

An apparatus for data processing is described. The apparatus may include a processor, memory in electronic communication with the processor, and instructions stored in the memory. The instructions may be executable by the processor to cause the apparatus to register a first user identifier and a first object identifier as a first entry to an object user map responsive to a request for a first object associated with the first object identifier by a client system associated with the first user identifier, the object user map including a set of entries, detect a change event corresponding to a second object of a set of objects including the first object, the second object associated with a second object identifier, determine whether the second object identifier corresponds to at least one object identifier of the object user map, and transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

Another apparatus for data processing is described. The apparatus may include means for registering a first user identifier and a first object identifier as a first entry to an object user map responsive to a request for a first object associated with the first object identifier by a client system associated with the first user identifier, the object user map including a set of entries, detecting a change event corresponding to a second object of a set of objects including the first object, the second object associated with a second object identifier, determining whether the second object identifier corresponds to at least one object identifier of the object user map, and transmitting a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

A non-transitory computer-readable medium storing code for data processing is described. The code may include instructions executable by a processor to register a first user identifier and a first object identifier as a first entry to an object user map responsive to a request for a first object associated with the first object identifier by a client system associated with the first user identifier, the object user map including a set of entries, detect a change event corresponding to a second object of a set of objects including the first object, the second object associated with a second object identifier, determine whether the second object identifier corresponds to at least one object identifier of the object user map, and transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

Some examples of the method, apparatuses, and non-transitory computer-readable medium described herein may further include operations, features, means, or instructions for determining whether the change event may be one of a update event and a delete event, and transmitting the change event indication responsive to determining the change event may be one of the update event and the delete event.

Some examples of the method, apparatuses, and non-transitory computer-readable medium described herein may further include operations, features, means, or instructions for determining whether the at least one client system may be connected via a streaming link, and transmitting the change event indication responsive to determining the at least one client system may be connected via the streaming link.

Some examples of the method, apparatuses, and non-transitory computer-readable medium described herein may further include operations, features, means, or instructions for determining that the second object identifier corresponds to the first object identifier, and transmitting the change event indication to the client system associated with the first user identifier.

Some examples of the method, apparatuses, and non-transitory computer-readable medium described herein may further include operations, features, means, or instructions for removing a third entry from the object user map after a predetermined period of time if a client system fails to request the object identified in the entry during the predetermined period of time.

Some examples of the method, apparatuses, and non-transitory computer-readable medium described herein may further include operations, features, means, or instructions for generating a change event object corresponding to the detected change event, the change event object including an indication of a change event type, the second object identifier, a timestamp associated with the change event, or a combination thereof.

Some examples of the method, apparatuses, and non-transitory computer-readable medium described herein may further include operations, features, means, or instructions for retrieving the at least one user identifier corresponding to the second entry including the second object identifier from the object user map.

In some examples of the method, apparatuses, and non-transitory computer-readable medium described herein, the object user map may be implemented as a cache system.

In some examples of the method, apparatuses, and non-transitory computer-readable medium described herein, the change event indication indicates the second object identifier, a change event type, a timestamp associated with the change event, or a combination thereof.

In some examples of the method, apparatuses, and non-transitory computer-readable medium described herein, the at least one client system includes at least two client system types.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
registering a first user identifier and a first object identifier as a first entry to an object user map responsive to a request for a first object associated with the first object identifier by a client system associated with the first user identifier, the object user map comprising a plurality of entries;
detecting a change event corresponding to a second object of a plurality of objects including the first object, the second object associated with a second object identifier;
determining whether the second object identifier corresponds to at least one object identifier of the object user map; and
transmitting a change event indication to at least one client system associated with at least one user identifier responsive to determining that the second object identifier corresponds to the at least one object identifier of the object user map, each of the at least one user identifiers corresponding to second entry in the object user map including the at least one object identifier, the change event indication indicating the change event corresponding to the second object corresponding to the second object identifier.

2. The method of claim 1, further comprising
determining whether the change event is one of a update event and a delete event; and
transmitting the change event indication responsive to determining the change event is one of the update event and the delete event.

3. The method of claim 1, further comprising:
determining whether the at least one client system is connected via a streaming link; and
transmitting the change event indication responsive to determining the at least one client system is connected via the streaming link.

4. The method of claim 1, further comprising:
determining that the second object identifier corresponds to the first object identifier; and
transmitting the change event indication to the client system associated with the first user identifier.

5. The method of claim 1, further comprising:
removing a third entry from the object user map after a predetermined period of time if at least one client system fails to request an object identified in the third entry during the predetermined period of time.

6. The method of claim 1, further comprising:
generating a change event object corresponding to the detected change event, the change event object including an indication of a change event type, the second object identifier, a timestamp associated with the change event, or a combination thereof.

7. The method of claim 1, further comprising:
retrieving the at least one user identifier corresponding to the second entry including the second object identifier from the object user map.

8. The method of claim 1, wherein the object user map is implemented as a cache system.

9. The method of claim 8, wherein the cache system includes a first in first out (FIFO) queue data structure including the plurality of entries.

10. The method of claim 1, wherein the change event indication indicates the second object identifier, a change event type, a timestamp associated with the change event, or a combination thereof.

11. The method of claim 1, wherein the at least one client system includes at least two client system types.

12. An apparatus for data processing, comprising:
a processor,
memory in electronic communication with the processor; and
instructions stored in the memory and executable by the processor to cause the apparatus to:
register a first user identifier and a first object identifier as a first entry to an object user map responsive to a request for a first object associated with the first object identifier by a client system associated with the first user identifier, the object user map comprising a plurality of entries;
detect a change event corresponding to a second object of a plurality of objects including the first object, the second object associated with a second object identifier;
determine whether the second object identifier corresponds to at least one object identifier of the object user map; and
transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

13. The apparatus of claim 12, wherein the instructions are further executable by the processor to cause the apparatus to:
determine whether the change event is one of a update event and a delete event; and
transmit the change event indication responsive to determining the change event is one of the update event and the delete event.

14. The apparatus of claim 12, wherein the instructions are further executable by the processor to cause the apparatus to:
determine whether the at least one client system is connected via a streaming link; and
transmit the change event indication responsive to determining the at least one client system is connected via the streaming link.

15. The apparatus of claim 12, wherein the instructions are further executable by the processor to cause the apparatus to:
determine that the second object identifier corresponds to the first object identifier; and
transmit the change event indication to the client system associated with the first user identifier.

16. The apparatus of claim 12, wherein the object user map is implemented as a cache system.

17. A non-transitory computer-readable medium storing code for data processing, the code comprising instructions executable by a processor to:
register a first user identifier and a first object identifier as a first entry to an object user map responsive to a request for a first object associated with the first object identifier by a client system associated with the first user identifier, the object user map comprising a plurality of entries;
detect a change event corresponding to a second object of a plurality of objects including the first object, the second object associated with a second object identifier;
determine whether the second object identifier corresponds to at least one object identifier of the object user map; and
transmit a change event indication to at least one client system associated with at least one user identifier responsive to determining that the second object identifier corresponds to the at least one object identifier of the object user map, each of the at least one user identifiers corresponding to a second entry in the object user map including the at least one object identifier, the change event indication indicating the change event corresponding to the second object corresponding to the second object identifier.

18. The non-transitory computer-readable medium of claim 17, wherein the instructions are further executable to:
determine whether the change event is one of a update event and a delete event; and
transmit the change event indication responsive to determining the change event is one of the update event and the delete event.

19. The non-transitory computer-readable medium of claim 17, wherein the instructions are further executable to:
determine whether the at least one client system is connected via a streaming link; and
transmit the change event indication responsive to determining the at least one client system is connected via the streaming link.

20. The non-transitory computer-readable medium of claim 17, wherein the instructions are further executable to:
determine that the second object identifier corresponds to the first object identifier; and
transmit the change event indication to the client system associated with the first user identifier.
